(19) United States
(12) Patent Application Publication
(10) Pub. No.: US 2019/0143224 A1
(43) Pub. Date: May 16, 2019

(54) FANTASY SPORTS SYSTEM AND PROCESS

(71) Applicant: Ryan Melissinos, Bristow, VA (US)

(72) Inventor: Ryan Melissinos, Bristow, VA (US)

(21) Appl. No.: 15/814,393

(22) Filed: Nov. 16, 2017

(51) Int. Cl. A63F 13/828; G06F 17/50

(52) U.S. Cl. CPC A63F 13/828; A63F 2300/407; G06F 17/5009

(57) ABSTRACT

The present invention includes a fantasy sports league that provides users flexibility to alter team dynamics up to and including time of the game applicable to a player's statistics. The present invention communicates with users to advise them of alteration potential.

### FIELD OF THE INVENTION

The present invention relates to the field of fantasy games and more specifically to the field of fantasy sports leagues.

### BACKGROUND

A fantasy league can be operated by a fantasy site on the Internet utilizing a server based system, like FanDuel, Yahoo Fantasy Sports, and ESPN Fantasy Games, among other fantasy sites. Fantasy sites allow patrons to compete against friends or random patrons either for free or with a bet to win money based on the performance of the patron (Fantasy sites allow patrons to compete against friends or random patrons either for free or with a wager to win money or other prizes based on the performance of their selected athlete lineups). The competition can occur a single time or can be recurring, for example, a league of multiple competitions. In some modes, patrons are given a fixed size pool of in-game money, referred to as a salary cap, and the patrons can select players participating in a sporting event, with each player being assigned an in-game monetary cost. A cost can be associated with each of the sports players participating in a game or collection of games. Each patron can select sports players from the pool of participating sports players, where each selected sports player cost is counted against a patron's in-game money.

### SUMMARY

The present invention is directed to a fantasy sports league simulator. The present invention is adaptable to any multi-game season of a sports league. A league roster pool is aggregated of general athletes for a sports season from a sports league. A user may create a fictitious team roster list of selected athletes that are participating in the sports league. The present invention monitors realtime sports games and athlete information to acquire attributes related to the general sports players. Sports games information may include such attributes as game statistics. Athlete information preferably includes biographical information such as arrests, inactivity, injuries, etc. The information received in the monitoring step is tested against the athletes selected by the user for its fictitious team. By testing it is meant that the athlete is subjected to a series of tests involving Boolean values and scalar values. Examples of Boolean values include indications of injury, indications of inactivity, and other attributes that can be indicated by an affirmation or negative. Examples of scalar values include performance attributes from a game. The present invention features benchmarks of athletic performance, whereby an underperforming athlete can fail the benchmark comparison of the testing step.

A selected athlete that underperforms can be the subject of a substitution suggestion automatically transmitted by the present invention. The substitution suggestion provides an alert to a user that a selected athlete from its fictitious team has failed a test. The Substitute suggestion may simply indicate that a selected athlete has underperformed relative to a benchmark, or may further include a suggestion for a replacement athlete. The user may re-access the roster of its fictitious team to exchange a selected athlete with a replacement athlete.

It is imperative, however, to maintain a fantasy league as a game-of-skill. Therefore, the present invention includes calculating an exchange consideration based on the replacement athlete—if a selected athlete is so replaced. A team score is generated based on the fictitious team at the time of completion of the athlete roster as modified for that particular period.

The backend system will continuously monitor the data being fed from data providers in order to identify what is happening to athletes during their games. Upon receiving information calling for an alert, the present invention will identify those users that have the affected athletes within their lineups and send out the alerts to their used platforms (mobile, desktop, etc). Users that choose to use the feature will then initiate a call to our backend system (clicking a predetermined button) that will request a fee in order to complete the swap. Once the fee has been paid by the users, the backend will release the players available for selection in games that have not begun yet. Once a selection has been made and swap has been confirmed successful, the backend system may lock the lineup of the user until the games are completed. Once games have been completed, a portion of the funds brought in by the host will be then redistributed back out to the winning group of users.

Therefore, it is an aspect of the present invention to permit the modification of a fantasy league team roster during season play while maintaining a financial penalty for such modifications. These aspects of the invention are not meant to be exclusive. Furthermore, some features may apply to certain versions of the invention, but not others. Other features, aspects, and advantages of the present invention will be readily apparent to those of ordinary skill in the art when read in conjunction with the following description, and accompanying drawings.

### BRIEF DESCRIPTION OF THE DRAWINGS

FIG. 1 is a view of the process of the present invention.

FIG. 2 is a view of the process of the present invention.

FIG. 3 is a view of the process of the present invention.

FIG. 4 is a view of the process of the present invention.

FIG. 5 is a view of the ecosystem of the present invention.

FIG. 6 is a view of the ecosystem of the present invention.

### DETAILED DESCRIPTION

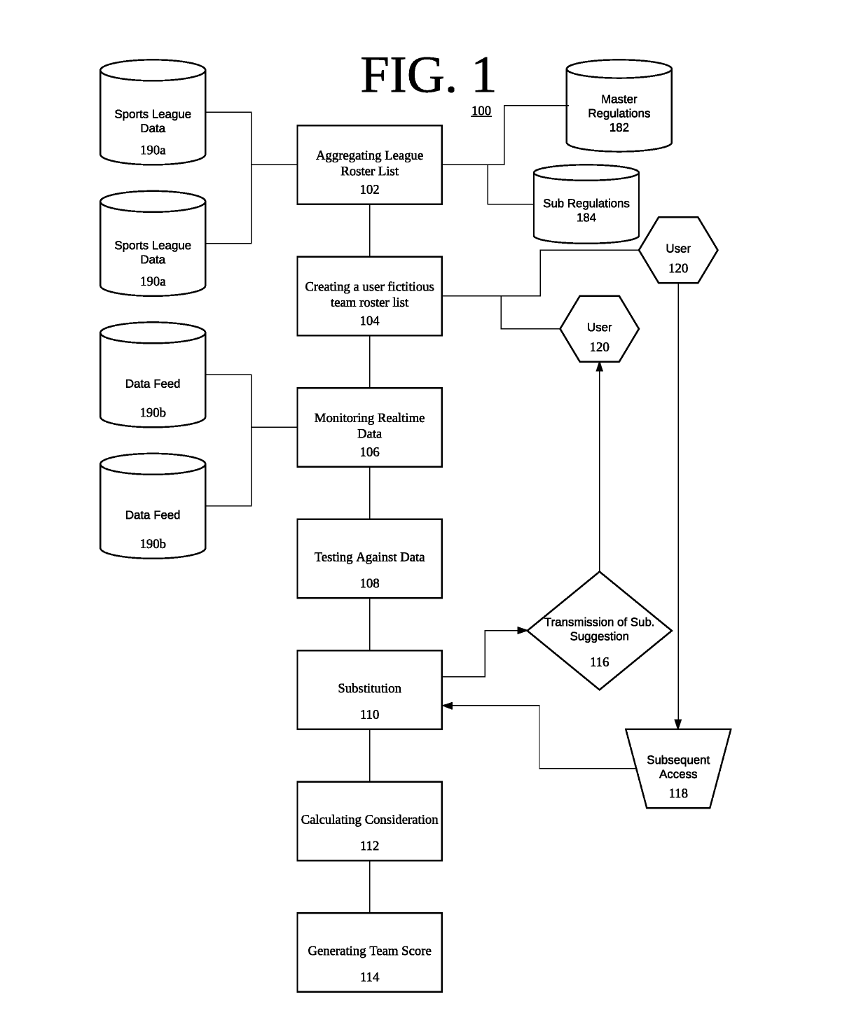

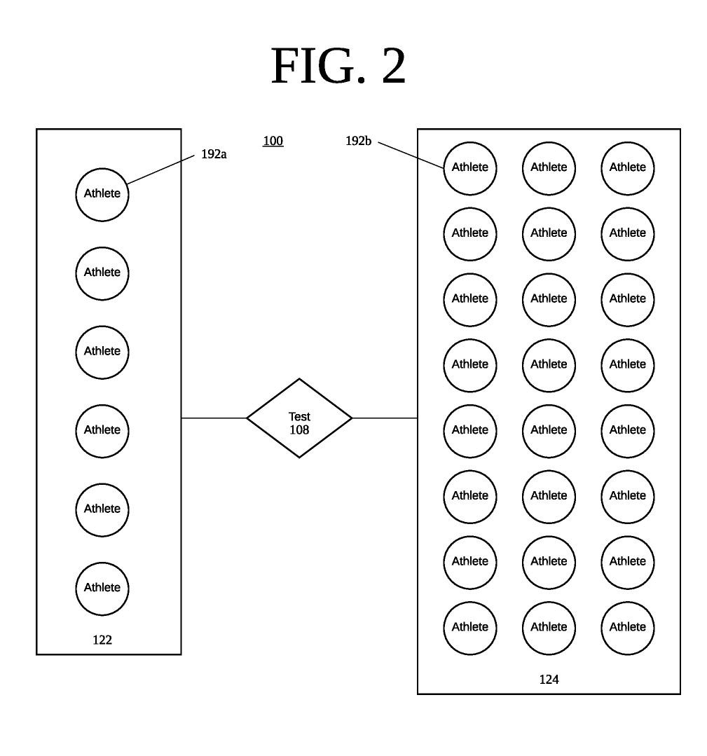

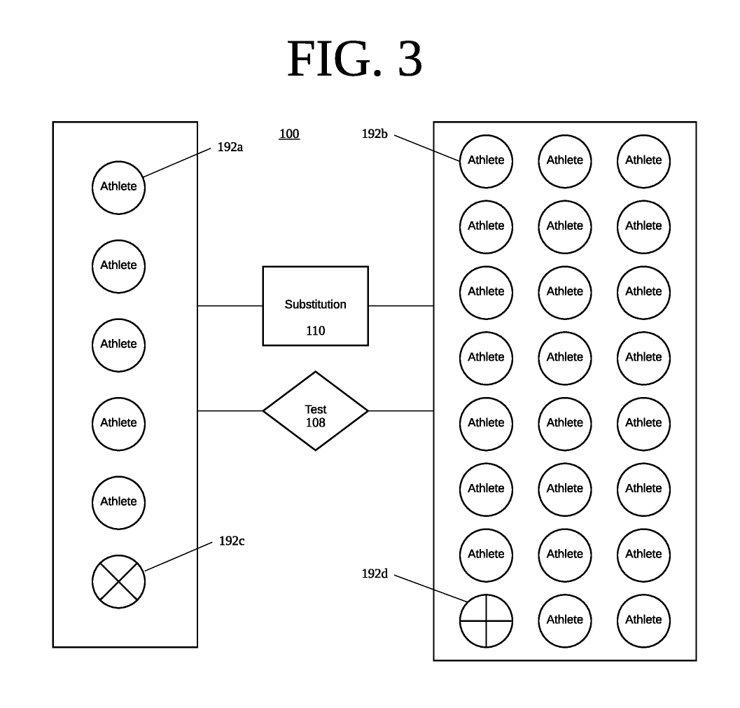

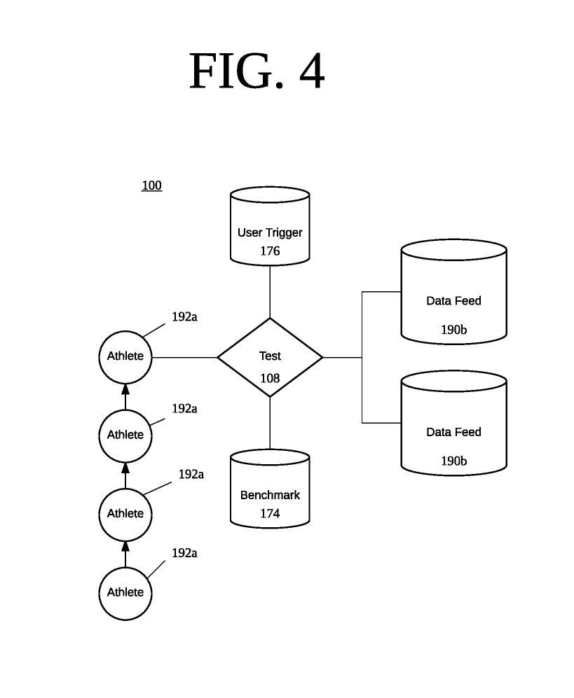

Referring first to FIGS. 1-4, a basic embodiment of the Fantasy League process 100 is shown. A fantasy league can be applied to any sport or competitive endeavor. Preferred leagues to which a fantasy league may be applied include baseball, football, soccer, basketball, hockey, cricket, and automobile racing leagues. Sports league data 190a from one or more leagues are aggregated 102 by an engine of the present process to acquire roster data. The data permits the creation of a roster pool 124 of general athletes 192b. A user 120 accesses the process 100 to create a fictitious team 122 of selected athletes 192a.

The user team 122 includes a series of selected athletes 192a generally representing a completed team by position of athletes chosen from the pool 124 of general athletes 192b. The team of selected athletes may include any manner of a completed team as it is understood in the fantasy sports industry. A team of selected athletes may include only starters, both starters and a second team, or something less than a total team, e.g., a team of only specific skill positions. The process may utilize a draft among users and/or a points-based system that applies a cost ratio to each player based on prior performance. The users 120 have on their teams 122 their respective athletes and may compete one with the other once games/events begin.

The present invention is particularly applicable to daily fantasy sports. The primary difference between daily fantasy sports and season-length fantasy sports is that daily fantasy leagues only require that fantasy owner-users generally select athletes for a specific period. For baseball or basketball, the period may be one day; for the football games, the typical period is one week. Player selection in daily fantasy is often effected with a “salary cap” in place of the usual sequential draft. In this format, players do not care about long-term play and pay little regard to bad situations, and instead emphasize finding the highest amount of production at the lowest cost and creating the most complete squad. Daily fantasy sports requires a strategy that differs from season-length fantasy sports, and the present invention provides means of modifying rosters that maintain an acceptable level of competition.

The process 100 monitors 106 real-time data 190b in many and varied forms. By real-time data it is meant that the data is current as of the time of play of the selected athletes of the user. The monitor 106 may provide constant monitoring as well, such that data pertinent to the user 120 is constantly acquired and transmitted 116 to the user 120. Data feeds 190b may relate to any information that may affect gameplay of an athlete. Exemplary data feeds include two types: gameplay data, and biographical data. Gameplay data includes those attributes, statistics, and circumstances that are directly related to play/activity at the time of play/activity. Gameplay activity will vary greatly based on the sport. In baseball for example, the activity may include balls, strikes, hits, steals, bases, walks, homeruns, etc. Biographical data includes activities and circumstances related to the life situations of the athletes. Biographical data may be related to gameplay tangentially; examples of highly pertinent biographical data include injuries, disqualifications, suspensions, etc. Other biographical data may be indirectly related to gameplay, such as weddings, funerals, arrests, intoxication, charity events, fights, negative feedback from practice, etc. The purpose of the monitor 106 is to aggregate data related to athletes to permit a test 108 to determine the fitness of an athlete for athletic participation.

A preferred form of real-time data that is advantageous to monitor from a live feed is game/activity conclusion data. For purposes of the substitution, that will later be described, it may be significant to categorize athletes into two states: available and forbidden. An available state means that the athlete has either not yet played or has not yet concluded play; an unavailable state means that the athlete has concluded play for the particular game/event or that a player does not fit into applicable game parameters, e.g. salary cap requirements.

The present invention tests 108 data, particularly during periods of game/event activity. The tests 108 include any of a series of questions related to selected athletes 192a, including Boolean determinations. Examples of Boolean determinations include affirmative/negative circumstances, such as question of active status, injured status, suspended status, and the like. The tests may alternatively conclude in scalar quantities. The present invention utilizes not only direct data, but formulated data to determine athlete fitness of participation in an event. Benchmarks 174 may be utilized to rate the effectiveness of an athlete during gameplay or for life events. Other data that can be utilized is that a player swap can be engaged if a player is underperforming. This is ultimately decided upon from the user based on the data they are provided

A preferred benchmark measures production during a game/event, yet prior to the conclusion of the game/event such that the fractional production of the athlete is extrapolated to estimate a predicted total production. A benchmark includes two aspects, an extrapolation factor and a comparison factor. The extrapolation factor is important in the present invention because conclusions based on the benchmark should be delivered in a timely manner, which will generally be prior to the conclusion of the activity in which a selected athlete is participating. Examples of extrapolation factors include a multiplier based on time remaining vs. time passed in an event applied to an attribute. In football, an athletes first quarter performance may be multiplied by four to extrapolate a predicted production. Benchmarks may be selectively used based on specific factors, such as on an athlete-by-athlete basis or on a position-by-position basis or an attribute category-by-category basis. The overall production of a football quarterback, for example, cannot be accurately predicted based on interceptions; interceptions tend to bear little relationship to time passed or time remaining. A quarterback that throws one interception in a first quarter is unlikely to throw four interceptions in a game, either because an interception triggers a more cautious offensive pass strategy on the part of an offensive coordinator. However, the rushing yards of a running back in a first quarter in a professional football league can be an adequate predictor when multiplied by four because defensive miscues are less likely with professionals—and a primary determinant of aberrantly-long rushes are defensive miscues rather than rusher skill.

The second aspect of the benchmark includes the comparison factor. The comparison factor may include a result quantity that is arbitrarily-determined, statistically determined to be an average, statistically determined to be above a previous percentage of performers, or other meaningful quantity. The benchmark may be an overall benchmark, a benchmark that is calculated from a collection of sub-benchmarks, or a report of multiple individual benchmarks. The comparison factor that is based upon an average of prior performers will include a calculation of past athlete performances for the pertinent position for a predetermined period (e.g., season, week, portion of season, etc.). The average comparison factor for running backs may be a simple addition of the quantity of rushing yards divided by the quantity of running backs. Alternatively, the user may select the comparison factor to be in a range of performance, e.g., top 20% of running backs, top 10% of running backs, etc. In other instances a comparison factor may be a threshold, particularly for negative statistics such as interceptions (in football) or strike-outs (in baseball). When the comparison threshold is reached, the athlete may fail the particular test. The comparison threshold, as other thresholds, may be informed by user modification.

When the extrapolation factor is utilized in conjunction with the comparison factor, the benchmark result is calculated in a form that can be displayed to a user in a meaningful amount of time. Furthermore because multiple benchmarks may be utilized, preferably at least one per player, the present invention may utilize a benchmark screen that permits benchmark failures of only a particular magnitude to be prioritized. The prioritization may take the form of selection for transmission 116 to a user, placement at a special section of a webpage, display in a list ordered by magnitude, or other screening means.

The present invention permits replacement by substitution 110 in the fictitious user roster. The user includes a team 122 of selected athletes 192a that are frequently being tested 108. The general pool 124 of general athletes 192b includes either a total stock of athletes within a sports league, athletes not chosen by the particular user, or athletes not chosen by either the user or the third party users within whom the user is competing. There are two primary bases of substitution 110, user-initiated substation through subsequent access 118, and process-initiated substitution through an active transmission 116. A user 120 may avail itself of either substitution mechanism.

A preferred means of substitution 110 is through active transmission 116 of a substitution suggestion from the host system to the user 120. The testing 108 of the present invention may result in one or more “failed” tests wherein athletes are considered to be “failed athletes” 192c. As surely as selected athletes may be the subject of testing 108, including activity and benchmarking, the general athletes 192b may also be subject to testing 108. The test conclusions of the test 108 may be displayed to a user, including through prioritization based on the magnitude of passing one or more tests 108. An athlete may be selected as a “selected athlete” 192d by the process due to its fitness to replace the failed athlete. A transmission of a substitution suggestion may be based on simply the failure of an athlete pursuant to a test 108, or preferably, the transmission of a substitution suggestion may include a suggestion of a replacement athlete coupled with the information of the failed athlete.

The substitution suggestion transmission 116 that results in a substitution 110 may be triggered by a user trigger 176. The user trigger 176 may include a flag placed on a selected athlete or a targeted replacement athlete. The flag may be based on any attribute related to an athlete or benchmark. Preferred flags may include attributes from the data feed such as game-time substitution (i.e., out of the game/activity), a predetermined quantity of an attribute (e.g., passes, incomplete passes, rushes, rushes-for-loss, etc.), or some other meaningful quantity or Boolean.

Rather than rely purely on active transmission 116 by the host, the user may actively seek to re-access 118 the team roster 122 and the athletes 192a that comprise the same. The user 120 may scan the general pool 124 of general athletes 192b to select a replacement athlete. The system may augment the experience of the user by actively displaying a benchmark related to the general athletes as the user peruses the pool 124. The user may manually select a replacement athlete irrespective of whether a failed athlete exists.

The nature of daily fantasy sports is a game of skill and the allowance of users to substitute failing players for more successful players can negate the skill aspect of daily fantasy sports unless balanced by a mitigating factor. The present invention mitigates the existence of persistent substitutions by calculation 112 of a financial penalty as consideration for the substitution. The preferred consideration to make a swap is half of the original entry fee cost, By way of example, if entry fee is $2.50, then the swap cost is $1.25. The cost may, or may not be, adjusted based on the level of the player being acquired from swap. When a swap is executed, the score from the previous player is removed and the new player will be added into their lineup. The new score is based on how the swapped player performs. The feature calls for one-time fee to be paid in order to execute a swap of a player. This swap currently carries a fee of half the original entry fee, but cost could change depending on popularity, use, etc. Other embodiments of the present invention may utilize multiple swaps allowed in a game with each swap calling for a fee, potentially an increase in fee relative to amount of swaps. For example, if an entry fee is $2.50 with a swap fee of $1.25 for a single swap, then the second swap at same entry fee cost would be $2.50. This fee structure, or course, will change depending upon the popularity, use, need, etc. This will also apply to custom games created by the users with the ability to limit the amount of swaps based on their custom game creation feature selections.

Once the consideration has been calculated 112, the system generates a team score 114. The team score 114 is based on the user team 122 as finalized by the user rather than as started at the beginning of the grading period. The grading period may include any period of activity in a league that can have a meaningful beginning and conclusion.

The present invention may allow the host system to lock 184 any additional substitutions. A user may be permitted a finite number of substitutions based on quantity or some other criteria. For example, the substitutions may be accorded a score based on the magnitude of the consideration calculated 112 by the system. The present invention features multiple sets of regulations 182, 184. Master regulations 182 may be issued by the host to control the league rules of the fantasy league play. Examples of master regulations include league types, team names, team logos, setting draft lists, draft pick methodologies (e.g., snake or autopick or auction), scoring formats, scoring corrections, position eligibility, position eligibilities, injury designations, injured reserve, maintenance periods, etc. Furthermore, regulations may be set at less than system-wide level. Subregulations 184 may relate to groups or other subunits of users of the process 100, and these subunits may establish regulations peculiar to that group. One of the featured regulations or subregulations of the present invention is the ability to lock 184 the number of subsequent substitutions via subsequent access 118. Regulations that exist at the master level may by adjusted at the sub-regulation level, in which case, these regulations may present in both master and sub-level, sometimes differing, sometimes not. Nonetheless, the feature may exist such that a group leader/coordinator may alter the regulations of the league. Locking may be altered to be impermissible, permissible at a certain number of times per game period, or a certain number of times for season period. Furthermore, another preferred alterable subregulation includes fees associated with subsequent accesses, to either increase the financial stigma associated therewith or lessen it.

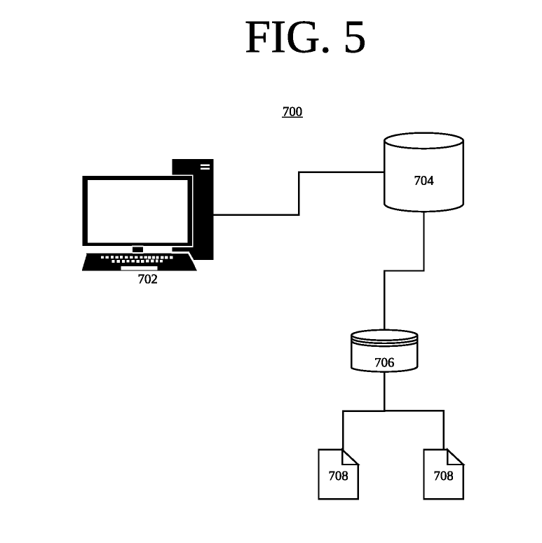

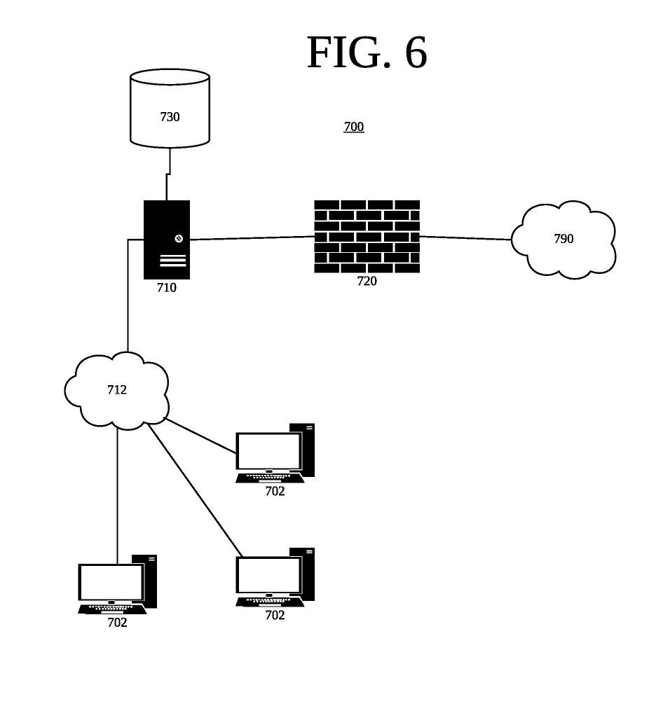

FIGS. 5-6 depict a computer ecosystem 700 of the present invention. By ecosystem it is meant one or more computers 702 that are organizationally related. The ecosystem may include computers under common ownership, computers that belong to the same network or series of networks, computers that are collaborating, etc. The present invention may be provided as a computer program product, or software that may include a computer-readable storage medium 704 having stored thereon instructions, which may be used to perform the process of the present invention across a computer ecosystem 700 according to the various embodiments disclosed herein.

A computer 702 of the present invention may include any combination of one or more computer readable media 704. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium 704 may be any tangible medium that can contain, or store a program for use by or in connection with an instruction execution system, apparatus, or device.

A computer readable signal medium 704 may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures described below illustrate the to architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Furthermore, the functionality of one block may be subsumed by the functionality of another block as a substep thereof. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

An ecosystem 700 may further include a computer network or data network that allows computers to exchange data. In a computer network of the present invention, networked computing devices pass data to each other along data connections. The connections between nodes are established using cable media, wireless media, or other media. The Internet or other exterior network 790 may be a component of the ecosystem 700. Nodes may include hosts such as personal computers, phones, servers, and networking hardware. Two such devices are networked together when one device is able to exchange information with the other device, whether or not they have a direct connection to each other. Computer networks of the present invention support applications such as access to the World Wide Web, shared use of application and storage servers, printers, and fax machines, and use of email and instant messaging applications. Computer networks may be included irrespective of the physical media used to transmit their signals, the communications protocols to organize network traffic, the network's size, topology, and organizational intent.

It is preferred that the network of the present invention have at least one boundary 720, and potentially multiple boundaries if a demilitarized zone is utilized. The boundary 720 may include any number of layers designed to regulate and secure the flow of information between networks. Boundary layers of the present invention may include enterprise content management software, firewalls, filters, threat management software, alarms, etc. Software for establishing a boundary may be run on a server 710 with server storage 730 of the present invention, which may include directory services controlling access credentials.

To combat security risks posed by network connections, firewalls are frequently used. A firewall may be a hardware or software component that filters network traffic so that communications with unauthorized third parties are blocked but legitimate network functions may be carried out. Frequently, the filters applied by a firewall are specified by a set of policies defining characteristics of network messages that either should pass through the firewall or that should be blocked. Because different levels of communication may be appropriate depending on the origin or destination of messages, firewall policies may be provided for each application that executes on a computing device and communicates over a network.

A firewall may have an outward side facing a global network, such as the Internet. The opposite side of the firewall may be a private network that is protected by the firewall. The private network may include any number of host machines (e.g., computers) each addressable by its own IP address. The physical construction of the network may be such that all data packets intended for one of the IP addresses behind the firewall pass through the firewall. Using the firewall rules, which may be set by a network administrator or other user, the firewall may determine whether to allow or deny certain data packets and/or determine where to route particular data packets based on the IP addresses to which the packets are directed. The determination of where to route data packets may be done using the IP addresses of the host machines in the private network.

Depending on the addressing scheme used by the network, the IP addresses of the host machines may be static or dynamic. Static IP addresses do not change over time, and thus once they are set in the firewall rules, there is no need to update them. The Internet Protocol version Four (IPv4) addressing system commonly uses static addressing, while IPv6 may use dynamic addressing. Dynamic IP addresses may change over time and thus, there is a need to update the firewall rules as changes occur. When a small Local Area Network (LAN), such as a domestic network in a private residence, is linked to a larger network such as the Internet, the link is often through a gateway router acting as a firewall. One of the functions of the firewall is to protect the LAN from intrusion from outside.

A service directory accessible by a server 710, usually on server storage 730, stores information about network resources across a domain. An example of a directory service is Active Directory. The main purpose of Active Directory is to provide central authentication and authorization services for Windows-based computers. Active Directory also allows administrators to assign policies, deploy software, and apply critical updates to an organization. Active Directory stores information and settings in a central database.

An Active Directory structure is a hierarchical framework of objects. The objects fall into three broad categories: resources (e.g. printers), services (e.g. e-mail) and users (e.g., user accounts and groups). The Active Directory provides information on the objects, organizes the objects, controls access and sets security. Certain objects can also be containers of other objects. An object is uniquely identified by its name and has a set of attributes—the characteristics and information that the object can contain—defined by a schema, which also determines the kind of objects that can be stored in the Active Directory.

Typically, the highest object in the hierarchy is the domain. The domain can be further sub-divided into containers called Organizational Units. Organizational units give a semblance of structure to the organization either based on administrative structure or geographical structure. The organizational unit is the common level at which to apply group policies, which are Active Directory objects themselves called Group Policy Objects. Policies can also be applied to individual objects or attributes as well as at the site level (i.e., one or more IP subnets).

The present invention may use one of more communication networks to foster information exchange throughout the computers of the ecosystem. Communication networks might either be private or public. In a private network, communications between multiple computers occur in a secure environment that prevents access from outside the network without appropriate authentication. These networks are considered as “trusted” networks because the communication signals securely travel from one computer to another within the private network without being exposed to the external environment.

Public networks such as the Internet, on the other hand, are not secure because the communication over these networks is not private and is susceptible to interception by other computers. In addition, the public networks cannot guarantee the delivery of the data packets being sent. They allow packets to be injected into, or ejected out of, the networks indiscriminately, and analyzed while in transit. To keep data sent over a public network private, a Virtual Private Network (VPN) is commonly established on top of a public network when two computers use the public network to communicate with each other. In a Virtual Private Network, data sent from one computer to another is encrypted by a security gateway and transmitted in encrypted form over the public network to a second security gateway connected to the receiving computer. The second gateway decrypts the data before forwarding it to the receiving computer. Such a private channel established on top of another network is referred to as a network tunnel.

In order to set up a Virtual Private Network, a user first establishes a path to a VPN server and goes through an AAA process (Authentication, Authorization and Accounting) for identification and authorization to create a secure tunnel with the server. Once the user is authorized, a secure network tunnel is established between the user and the VPN server over the public network, using a VPN protocol such as IPsec. This process requires a VPN client on the user's side, a VPN server and other VPN hardware on the other side of the tunnel, as well as appropriate user configurations.

Today's private networks often include wireless networks such as WiMAX to accommodate mobile access. In addition, to provide mobility access in a large geographic area, a private enterprise often relies on third-party wireless infrastructures besides its own wireless network. In this case, a user's device would need to be authenticated by both a third-party gateway and an enterprise authentication server before it could access the enterprise network. User credentials are typically requested by and securely returned to the third-party gateway. Once the user is authenticated and authorized, the user may communicate with the third-party wireless gateway.

The present invention includes files 708, which may include executable instructions by which the present invention runs, or files upon and with which the present invention interacts. The documents may be on local storage 704 or shared storage 730 and be created, accessed, edited, and/or otherwise modified using any of a number of applications, including for example and without limitation Final Cut Pro, Avid, Microsoft Office applications (Word, Excel, Power Point, Outlook, Visio, etc.), Adobe Reader or Acrobat, AutoCAD, SolidWorks, or any other suitable document editing application. The content of the documents may be audio tracks, video clips, images, word processing documents, presentations, spreadsheets, business documents, engineering documents, databases, etc.

Although the present invention has been described in considerable detail with reference to certain preferred versions thereof, other versions would be readily apparent to those of ordinary skill in the art. Therefore, the spirit and scope of the appended claims should not be limited to the description of the preferred versions contained herein.

What is claimed is:

1. A fantasy game process comprising:
aggregating, from a computer having an arithmetic logic unit (“ALU”), a nontransitory computer-readable storage medium in signaled communication with said ALU, a league roster list of sports general athletes for a sports season of a sports league;
creating a user fictitious team roster list comprising selected athletes participating in said sports league;
monitoring realtime sports games and athlete information to acquire attributes related to said general sports players;
testing said selected athletes against said athlete biographical information and an athlete benchmark compared to realtime sports game athlete data;
transmitting to said user a substitution suggestion comprising an exchange proposal for a replacement athlete from said sports league to replace an athlete from said team roster list failing said testing step;
calculating an exchange consideration based on said replacement athlete; and
generating a team score based on said fictitious team roster.

2. The process of claim 1 wherein said transmitting step includes transmitting said substitution suggestion to said user during a game in which said target athlete is participating.

3. The process of claim 1 wherein said monitoring step includes bifurcating said general athletes into (i) an available state and (ii) a forbidden state based on a game finality status corresponding to said general athletes.

4. The process of claim 1 further comprising consummating said substitution suggestion and updating said user fictitious team roster with said athlete of said substitution suggestion.

5. The process of claim 1 further comprising locking said user fictitious team roster list subsequent to said transmitting step to prevent consummating said substitution suggestion.

6. The process of claim 1 further comprising the step of re-accessing said league roster list of sports general athletes subsequent to a season start to substitute at least one of said selected athlete from said user fictitious team roster with a replacement athlete from said sports general athletes.

7. The process of claim 6 further comprising displaying said exchange consideration for said replacement athlete and said general sports athletes at the moment of selection of said replacement athlete.

8. A fantasy game process comprising:
aggregating, from a computer having an arithmetic logic unit (“ALU”), a nontransitory computer-readable storage medium in signaled communication with said ALU, a league roster list of sports general athletes for a sports season of a sports league;
creating a user fictitious team roster list comprising selected athletes participating in said sports league;
monitoring realtime sports games and athlete information to acquire attributes related to said general sports players; and bifurcating said general athletes into (i) an available state and (ii) a forbidden state based on a game finality status corresponding to said general athletes;
testing said selected athletes against said athlete biographical information and an athlete benchmark compared to realtime sports game athlete data
re-accessing said league roster list of sports general athletes subsequent to a season start to substitute at least one of said selected athlete from said user fictitious team roster with an available state replacement athlete from said sports general athletes while displaying data from said testing step;
calculating an exchange consideration based on said replacement athlete; and
generating a team score based on said fictitious team roster.

9. The process of claim 8 further comprising the step of transmitting to said user a substitution suggestion comprising an exchange proposal for a replacement athlete from said sports league to replace an athlete from said team roster list failing said testing step;

10. The process of claim 9 wherein said transmitting step includes transmitting said substitution suggestion to said user during a game in which said target athlete is participating.

11. The process of claim 8 further comprising locking said user fictitious team roster list subsequent to said re-accessing step to prevent consummating said substitution suggestion.

12. The process of claim 8 further comprising updating said user fictitious team roster with a selected athlete from said re-accessing step.
